(19) United States
(12) Patent Application Publication
(10) Pub. No.: US 2009/0186637 A1
(43) Pub. Date: Jul. 23, 2009

(54) METHOD FOR COMBINED MESSAGE TRANSMISSION AND PROCESSING IN A TELECOMMUNICATION NETWORK

(75) Inventor: Markus Sonntag, Wien (AT)

Correspondence Address: LERNER GREENBERG STEMER LLP, P O BOX 2480, HOLLYWOOD, FL, 33022-2480, US

(73) Assignee: Nokia Siemens Networks GmbH &Co., KG, Munchen (DE)

(21) Appl. No.: 12/300,425

(22) PCT Filed: May 11, 2007
(86) PCT No.: PCT/EP2007/054590

§ 371 Date: Dec. 10, 2008

(30) Foreign Application Priority Data
Mar. 11, 2006 (DE) 102006022111.7

(51) Int. Cl. H04W 4/12

(52) U.S. Cl. 455/466

(57) ABSTRACT

Method for combined message transmission and processing in a telecommunication network, in particular as an application as part of a data service in a mobile radio network or on the IMS platform, in which a plurality of connected telecommunication terminals respectively communicate with one another in a multistep sequence.

### CLAIM FOR PRIORITY

This application is a national stage application of PCT/EP2007/054590, filed May 11, 2007, which claims the benefit of priority to German Application No. 10 2006 022 111.7, filed May 11, 2006, the contents of which hereby incorporated by reference.

### TECHNICAL FIELD OF THE INVENTION

The invention relates to a method for combined message transmission and processing in a telecommunication network, which can be implemented, in particular, as an application as part of a service, in which a plurality of connected telecommunication terminals respectively communicate with one another in a multistep sequence.

### BACKGROUND OF THE INVENTION

A response function, which simplifies operation and in which the person receiving a message from a first mobile radio terminal can access the sender's telephone number, which is stored when the message is received, by pressing a button and can immediately send a response to the sender without having to enter the latter's telephone number again, has already been provided in a conventional short message service. A further convenience function in this service is the forwarding function which is used to transmit a first message, which was sent to a first recipient or was received from a first sender, to a further subscriber in the original format or with certain additions, if appropriate also an audio or video file attachment.

Furthermore, chat functions between a plurality of subscribers are also known as part of the known SMS and IMS services and are implemented in the networks. Recently, the applicant also presented mobile radio terminals which provide the device requirements for so-called push-and-talk (PaT) sessions which likewise enable a type of “conversation” between a group of subscribers in a simple and rapid manner.

### SUMMARY OF THE INVENTION

The invention is based on improved system and method which further enhances the possibilities for using the services mentioned and makes them even more attractive to the network subscribers. At the same time, the network loading and thus profitability should thus be improved.

More specifically, the invention relates to a method for combined message transmission and processing in a telecommunication network, which can be implemented, in particular, as an application as part of a service—to be precise especially a Short Message Service (SMS) or Media Message Service (MMS) in a mobile radio network or on the new data service platform Internet Protocol Multimedia Subsystem (IMS), in which a plurality of connected telecommunication terminals respectively communicate with one another in a multistep sequence.

### BRIEF DESCRIPTION OF THE DRAWINGS

The invention is described below with reference to exemplary embodiments and in conjunction with the figures, in which:

FIG. 1 shows a flow of the method in accordance with one example of the invention.

### DETAILED DESCRIPTION OF THE INVENTION

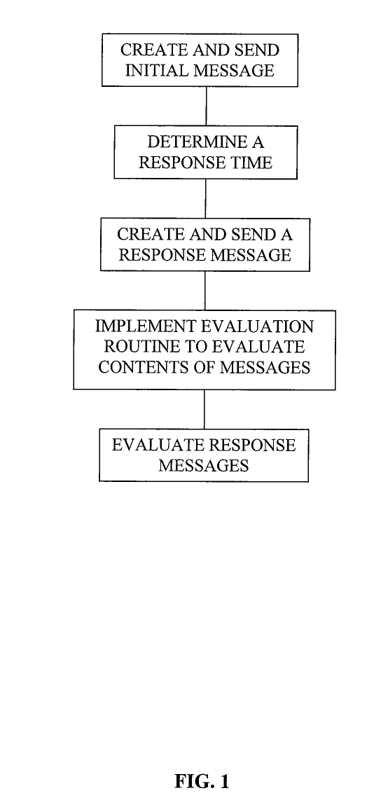

With reference to FIG. 1 of the invention, there is the creation and sending of an initial message from a first terminal to a plurality of second terminals selected from an electronic directory in a point-to-multipoint mode. It is therefore fundamentally a broadcast step but with a limited number of addressed terminals and is comparable to the simultaneous send of an SMS to a plurality of addressees or to the “push” in PaT according to the prior art.

In this case, the determination of a first response time and the transmission of the latter in the first message and the storage of the response time in the first terminal or in the telecommunication network with an indicator for transmitting a first time expiry message to the first terminal when the first response time expires. The response time mentioned is thus stored inside the terminal or inside the network and, in the latter case, signals the expiry of the response time, on the network side, to the terminal which starts the method.

The method sequence is continued by creating and sending response messages from at least some of the second terminals to the first terminal using a point-to-point or point-to-multipointresponse mode. This step corresponds per se to the known response mode in established SMS or IMS.

Another aspect of the method is the implementation of an evaluation routine for statistically evaluating contents of the second messages, which are predetermined when creating the first message, in the first terminal or in the telecommunication network, with write and read access by the first terminal. It goes without saying that the implementation will generally be carried out before the beginning of the actual communication sequence, that is the routine is stored inside the terminal or inside the network, the routine being provided, in the latter case, at the latest in response to a call from the first terminal.

In another aspect, the evaluation routine evaluates the response messages received from second terminals inside the response time. Since it relates to contents of the response messages, this use should be specified on the basis of the contents of the initial message and may, in principle, be effected automatically on the basis of predefined response templates or semi-automatically with the inclusion of a content evaluation by the user of the first terminal and according to classifying inputs to the evaluation routine.

In another embodiment, the method is concluded, after the response messages received inside the response time mentioned have been processed, by creating and sending an evaluation message, which contains or represents the evaluation result, from the first terminal to at least those second terminals which had sent a second message using the point-to-multipoint response mode. This evaluation message is used to inform the subscribers of the method sequence, for example, of the result of a survey which is started with the initial message and in which they have voted with their response messages.

In still another embodiment of the invention, the method is distinguished by the fact that a response routine for user guidance when creating the response messages is implemented in the terminals or in the telecommunication network, with read access by the terminals. This routine contains, in particular, a plurality of selectable response templates each having a reference to identifiers or list entries in the initial messages. In this respect, the selection routine which is preferably provided comprises a further development over the known template selection of established short message services, for instance with response templates whose important contents are in letters or numbers which are used to denote response possibilities predefined in the initial message.

In yet another embodiment of the invention, the method comprises a plurality of alternating steps for creating and sending first, second and optionally further initial messages from the first terminal and first, second and optionally further response messages from at least one of the second terminals. In this case, the second and possibly following initial messages, in particular, are configured, for their part, as response messages with respect to the first and possibly following response messages. They are sent at least to the terminal which sends the respective preceding response message, and a statistical evaluation is carried out only for those response messages which are sent in response to the respective last initial message.

This form of the transmission method makes it possible, for example as part of a voting procedure using a (an original) question which was posed with the initial voting message, to first of all communicate using a modification of the question introduced by one or more users of second terminals. Nevertheless, the technical support for evaluating the voting result, which is provided as part of the service, can still be used.

In one aspect of the invention, a response time is determined and stored with the (n-th) initial message which defines the definitive question. If this has already happened with the first initial message, the modified implementation of the method provides for the first response time, which has been determined and stored, to be automatically erased and to be replaced with the response time which was last valid.

An alternative to the aspect is distinguished by the fact that the response messages sent in response to the last initial message are not included in the evaluation but rather the respective last response messages from each terminal (irrespective of whether they have been sent after the last initial message or a preceding initial message). To remain with the selected example, this alternative also enables the responses given at preliminary stages of definitive questioning to be included in the evaluation. This transmission/evaluation sequence should naturally be determined only with regard to a suitable survey system.

In addition to the response time which has already been mentioned and sets the time frame for response messages to be evaluated, further response times which predefine the time frame for making the questioning more precise may be predefined and stored in the two abovementioned embodiments. In this refinement, the additional response times should not necessarily be respectively overwritten with a definitive response time since they apply to different initial response message constellations.

The last-mentioned aspect may have a further form to the effect that only the last response message of a plurality of response messages created and sent in one of the second terminals in response to the initial message or an initial message is actually taken into account for the evaluation, whereas preceding messages are not evaluated. This can be achieved, for example, by virtue of the fact that all response messages are not continuously included in the evaluation but rather the evaluation is started only after the response time has elapsed. This makes it unnecessary for responses which have already been evaluated but have been superseded by a subsequent response message to be “calculated” by the same terminal.

As an alternative, it is naturally also possible to erase response messages which have already been entered in the evaluation. Although this is more complicated and less reliable, this method sequence may be preferred if trend evaluations are intended to be possible as part of the overall method before the determined response time expires.

As an alternative to the handling of response messages which is organized strictly according to the time at which they are received, a refinement of the method in which the response routine provides a special response identifier for those response messages which are used to declare earlier response messages from the same terminal invalid is also possible, response messages declared invalid being excluded from the statistical evaluation.

In another aspect, the response routine provides for different types of response messages to be identified in terms of whether they contain a response to a question posed with the preceding initial message or a more precise statement of this question. Only response messages which can be identified as the first type of response messages by virtue of their identification are included in the statistical evaluation. This differentiation of the type of response messages, which can be understood as technical labeling, enables the parallel handling of “votes”, on the one hand, and modification and specification requests, on the other hand, in the voting process explained by way of example here. This parallel evaluation is also naturally expedient only when the structure of the survey has been set up in an appropriate manner.

In an embodiment, the initial messages and the response messages in the proposed method are pure text messages. Within the scope of a superior service, for instance on the IMS platform, the initial message or at least one initial message and/or the response message or at least one response message comprise(s) a text part and a graphic and/or a digital photo and/or a video stream and/or an audio or voice chip. With regard to the example of a survey or voting, it goes without saying that the text part must contain a question or must formulate a selection of responses.

If the initial message comprises a plurality of graphics, photos, video streams or audio/voice chips which are intended to be selected by the addressees, they are each assigned an identifier or a list entry in the text part. The templates preferably provided in the response routine then expediently contain a reference to that identifier.

In the voting example, the subscriber (user of a second terminal) can combine its response with data streaming or MIME templates when options are appropriately defined in the service. Corresponding response messages may be forwarded from the user of the first terminal (the moderator of the method) to the remaining subscribers in further initial messages. Overall, a multimedia configuration in the sense of a high level of appeal of the service is thus possible—however, the implementation of the method may also be strictly limited to simple question/answer constellations in the form of text.

Another aspect of the transmission method provides for the response messages to contain prediction statements and for the evaluation routine to comprise a section which is configured to statistically evaluate these prediction sections of the response messages, in particular. In the case of the implementation of the method which has already been mentioned further above and involves continuous evaluation of received response messages, not only projections but also betting charts relating to the outcome of the voting process can then be created and also transmitted to the subscribers in specific initial messages.

Another aspect, in combination with or as an alternative to the abovementioned aspect, involves combination with a betting service. In the case of this refinement, the user of the second terminals can define (before a “real” response message is created and sent or else at the same time as the latter) a stake which relates either to its own prediction statement or to a prediction transmitted by the moderator in an initial message. In this refinement, established components and sequences of known online betting systems are expediently resorted to, in particular on the IMS platform, with the result that a more accurate description can be dispensed with at this juncture.

As part of an appropriately configured evaluation and display system, it is not only possible to transmit the evaluation result to the subscribers via a system message but it is alternatively or additionally possible to transmit said result to other display devices or other message systems or networks. The subscribers outside the service may thus be informed, for instance, by means of radio broadcasting or television broadcasting or else by means of another broadcast service of the network operator. Both response messages inside the system and the display or transmission of the results by other means may contain graphical representations (for instance in the form of pie charts or bar charts which are known per se, curves etc.). For this purpose, the evaluation routine may contain graphics tools or is combined with a suitable graphics program.

Another aspect provides for the evaluation result to be kept secret from all of the subscribers or, at any rate, from some of the subscribers and/or the remaining public, that is to say evaluation messages are either not sent at all or are sent only to a circle of users (consequently users of third terminals) which differs from the circle of subscribers and are not transmitted to other message channels.

Another embodiment of the method is configured by making the subscribers (especially the users of the second terminals) anonymous. In this refinement, at least in order to evaluate the response messages (or the last response messages in the case of a multistage implementation of the method), the latter are made anonymous using suitable anonymizing means, which are known per se, and are provided with a unique identifier which allows only the faultless statistical evaluation but not the assignment of specific contents of the response message to a specific subscriber.

A forward-looking implementation of the proposed method is one on the IMS platform, in particular IMS 4.0, with a mobile radio network according to the GSM or UMTS standard as the access network. However, a cabled telecommunication network, WLAN etc. is also suitable, in principle, as the access network with regard to the network-integrating functionality of this novel data service architecture.

In one aspect of such a forward-looking service, it comprises the at least partial execution on a special voting application server and/or with access to a special voting SIP language packet.

In the case of an implementation which is tailored to state or else interstate devices and can be used to use the method in the context of problems of sovereignty or international law, the service is distinguished by secure access for users of first terminals in response to the running-through of a dedicated authorization procedure.

The embodiment of the invention is not restricted to the exemplary embodiments and aspects highlighted above but rather is likewise possible in a multiplicity of modifications which are part of expert action. In addition, the embodiment is not restricted to mobile radio networks of the established protocols and instant messaging service but rather is also possible, in principle, in other telecommunications networks.

1. A method for combined message transmission and processing in a telecommunication network, as an application as part of a data service in a mobile radio network or on an IMS platform, in which a plurality of connected telecommunication terminals respectively communicate with one another in a multistep sequence, comprising:
creating and sending an initial message from a first terminal to a plurality of second terminals selected from an electronic directory in a point-to-multipoint mode;
determining a first response time and transmitting the first response time in a first message and storing the first response time in the first terminal or in the telecommunication network with an indicator for transmitting a first time expiry message to the first terminal when the first response time expires;
creating and sending response messages from at least some of the second terminals to the first terminal using a point-to-point or point-to-multipoint response mode;
implementing an evaluation routine for statistically evaluating contents of second messages, which are predetermined when creating the first message, in the first terminal or in the telecommunication network, with write and read access by the first terminal; and
using the evaluation routine to evaluate the response messages received from second terminals inside the response time.

2. The method as claimed in claim 1,
wherein
a response routine for user guidance when creating the response messages is implemented in the terminals or in the telecommunication network, with read access by the terminals, the routine including a plurality of selectable response templates each having a reference to identifiers or list entries in the first messages.

3. The method as claimed in claim 1,
wherein
a plurality of respective alternating steps for creating and sending first, second and optionally additional initial messages from the first terminal and first, second and optionally additional response messages from at least one of the second terminals, the second and subsequent initial messages being configured as response messages with respect to the first and subsequent response messages and being sent at least to the terminal which sends the respective preceding response message, and a statistical evaluation being performed for response messages which are sent in response to the respective last initial message.

4. The method as claimed in claim 1 wherein,
a plurality of respective alternating steps for creating and sending first, second and optionally additional initial messages from the first terminal and first, second and optionally additional response messages from at least one of the second terminals, the second and subsequent initial messages being configured as response messages with respect to the first and subsequent response messages and being sent at least to the terminal which sends the respective preceding response message, and a statistical evaluation being performed for the respective last response message sent by a second terminal.

5. The method as claimed in claim 1 wherein
a plurality of respective alternating steps for creating and sending first, second and optionally additional initial messages from the first terminal and first, second and optionally additional response messages from at least one of the second terminals, the second and subsequent initial messages being configured as response messages with respect to the first and subsequent response messages and being sent at least to the terminal which sends the respective preceding response message, and a response routine providing for different types of response messages to be identified in terms of whether the response messages include a response to a question posed with the preceding initial message or a statement of the question, response messages which can be identified as the first type of response messages by virtue of their identification being included in the statistical evaluation.

6. The method as claimed in claim 5, wherein
the response routine provides a special response identifier for the response messages which are used to declare earlier response messages from a same terminal invalid, response messages declared invalid being excluded from the statistical evaluation.

7. The method as claimed in claim 1, wherein
at least one of the initial message or at least one initial message and the response message or at least one response message comprise at least one of a text part, a graphic, a digital photo, a video stream, and an audio or voice chip.

8. The method as claimed in claim 7, wherein
the initial message comprises at least one of a plurality of graphics, digital photos, video streams, and audio or voice chips which are each assigned an identifier or a list entry in the text part.

9. The method as claimed in claim 1, further comprising
creating and sending an evaluation message, which includes or represents the evaluation result, from the first terminal to at least those second terminals which had sent a second message using the point-to-multipoint response mode or to a plurality of third terminals which may comprise a predetermined subset of the second terminals.

10. The method as claimed in claim 1, wherein
the creation, display and/or sending of an evaluation file, which includes or represents the evaluation result, outside the telecommunication network.

11. The method as claimed in claim 1, wherein
at least in order to use the evaluation routine, the response messages are separated from the telephone number of the corresponding second terminal by anonymizing means and are provided with a unique identifier.

12. A service in a 3GPP mobile radio network, comprising a a program stored on a computer readable medium, executable by a computer, for combined message transmission and processing in a telecommunication network as an application in a mobile radio network or on an IMS platform, in which a plurality of connected telecommunication terminals respectively communicate with one another in a multi step sequence, comprising:
creating and sending an initial message from a first terminal to a plurality of second terminals selected from an electronic directory in a point-to-multipoint mode;
determining a first response time and transmitting the first response time in a first message and storing the first response time in the first terminal or in the telecommunication network with an indicator for transmitting a first time expiry message to the first terminal when the first response time expires;
creating and sending response messages from at least some of the second terminals to the first terminal using a point-to-point or point-to-multipoint response mode;
implementing an evaluation routine for statistically evaluating contents of second messages, which are predetermined when creating the first message, in the first terminal or in the telecommunication network, with write and read access by the first terminal; and
using the evaluation routine to evaluate the response messages received from second terminals inside the response time.

13. The service as claimed in claim 12, wherein
implementation occurs on the IMS 4.0 platform with a mobile radio network according to the GSM or UMTS standard as the access network.

14. The service as claimed in claim 13,
wherein at least partial execution occurs on a special voting application server and/or with access to a special voting SIP language packet.

15. The service as claimed in claim 12,
users of first terminals are secure in response to the running-through of a dedicated authorization procedure.
